(19) United States
(12) Patent Application Publication
(10) Pub. No.: US 2016/0225180 A1
(43) Pub. Date: Aug. 4, 2016

(54) Measurement tools with plane projection in rendered ultrasound volume imaging

(71) Applicant: Siemens Medical Solutions USA, Inc., Malvern, PA (US)

(72) Inventors: I-Ning Chang, Fremont, CA (US); Agnes Li-Sheiu Tsai, Santa Clara, CA (US)

(21) Appl. No.: 14/609,268

(22) Filed: Jan. 29, 2015

(51) Int. Cl. G06T 15/08; G06T 5/00; G06T 19/20; G06T 1/60; G06T 15/20; G06K 9/52; G06T 7/00

(52) U.S. Cl. CPC G06T 15/08; G06K 9/52; G06T 5/001; G06T 7/0012; G06T 1/60; G06T 15/20; G06T 19/20

(57) ABSTRACT

One or more planes used as part of volume rendering define the depth for measuring. A clip plane is used to crop parts of the volume to be rendered. A multi-planar reconstruction or reformation positions various cut planes to render two-dimensional imaging provided with the volume imaging. One of these planes is used to project a caliper position onto the plane for measurement using the volume rendering. The position of the calipers placed on the volume rendered image of the two-dimensional screen is converted to a location in three-dimensional space based on the plane position.

### BACKGROUND

The present embodiments relate to medical diagnostic imaging. In particular, measurement of anatomy using volume rendered imaging is provided.

Conventional two-dimensional measurement tools in ultrasound imaging are used to measure the distance or the area of anatomy on a two-dimensional ultrasound image. For measurement of anatomy represented in the two-dimensional image, users place one or more calipers on the two-dimensional computer screen. Since the two-dimensional image represents a planar region of the patient, the measurement is accurate.

For three-dimensional ultrasound imaging, data representing a volume of the patient is rendered to an image on the two-dimensional screen. Placing the calipers on the rendered image is ambiguous regarding depths in the three dimensional space as viewed in the rendering. Thus, when users use the calipers to measure the distance or the area of anatomy directly on the rendered ultrasound volumetric image, the resulting value may be for the two-dimensional screen but not the three-dimensional anatomy. Placement on the two-dimensional screen indicates placement in two xy components of the three dimensions. The resulting measure of three-dimensional anatomy may be inaccurate due to unknown depth of the z-component of the three dimensions.

### BRIEF SUMMARY

By way of introduction, the preferred embodiments described below include methods, computer-readable media and systems for measuring in ultrasound volume rendering. One or more planes used as part of volume rendering define the depth for measuring. A clipping plane is used to crop parts of the volume to be rendered. A multi-planar reconstruction (MPR) or reformation positions various cut planes to render two-dimensional images provided with the volume imaging. One of these clipping or cut planes is used to define depth based on projecting a caliper position on the cut or clip plane. The resulting three-dimensional location is used for measurement in volume rendering. The position of the calipers placed on the volume rendered image of the two-dimensional screen is converted to a location in three-dimensional space based on the plane position.

In a first aspect, a method is provided for measuring in ultrasound volume rendering. A volume rendered image of a volume of tissue scanned by ultrasound is displayed on a display. A graphic representing a clip plane or multi-planar reformation (MPR) cut plane is generated on the volume rendered image. A processor receives from a user input positioning of a measurement caliper on the volume rendered image and in the graphic representing the clip plane or cut plane. The processor uses the clip plane or cut plane relative to the volume and converts the positioning of the measurement caliper on the volume rendered image into a three-dimensional point position in the volume. The processor calculates a quantity as a function of the point position in the volume. The quantity is output.

In a second aspect, a system is provided for measuring in volume rendering. A memory is operable to store data representing a volume of a patient. A user input is configured to receive an indication of a position of a plane relative to the volume and a measurement location on a volume rendering of the volume. A processor is configured to generate the volume rendering of the volume from the data, to project a position in the volume from the measurement location on the volume rendered image and the position of the plane relative to the volume, and to calculate a value as a function of the position in the volume. A display is configured to display the volume rendering and the value.

In a third aspect, a non-transitory computer readable storage medium has stored therein data representing instructions executable by a programmed processor for measuring in ultrasound volume rendering. The storage medium includes instructions for: receiving from an input device a measurement location on a rendered volumetric image of a three-dimensional object; defining measurement depth relative to the three-dimensional object based on a position of a plane along a viewing direction of a rendered volumetric image; and measuring a spatial aspect of the three-dimensional object based on the measurement location and the measurement depth.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a flow chart diagram of an embodiment of a method for measuring in ultrasound volume rendering;

FIG. 2 is an example medical image showing MPR images with a volume rendered image;

FIG. 3 is an example medical image shows clip planes positioning and a volume rendered image; and

FIG. 4 is a block diagram of one embodiment of a medical imaging system for measuring in ultrasound volume rendering;

FIG. 5 illustrates a projection from a 2D mouse on the screen to a 3D point on a clip or cut plane in a volume being viewed.

### DETAILED DESCRIPTION OF THE DRAWINGS AND SPECIFIC EMBODIMENTS

Measurement tools are provided on a rendered ultrasound volumetric image using a plane projection approach. The caliper position on the two-dimensional screen or the rendered image is projected onto the multi-planar reformation or reconstruction (MPR) planes or onto the clip planes computed by the three-dimensional editing tools. The calipers are positioned in the volume rendering (VR) space rather than on two-dimensional displayed images. Where the caliper is placed, the depth is defined by the position of the clip or cut plane along the viewing direction of the volume rendered image at the time of placement. By deriving the depth from the plane, the user selected caliper position may be transformed to the three-dimensional Cartesian space of the volume being rendered. A direct or accurate volumetric image measurement is provided. The position of a plane along the viewing direction is used to define the depth information in the three-dimensional object being imaged for the purpose of manual measurements on the rendered volumetric images.

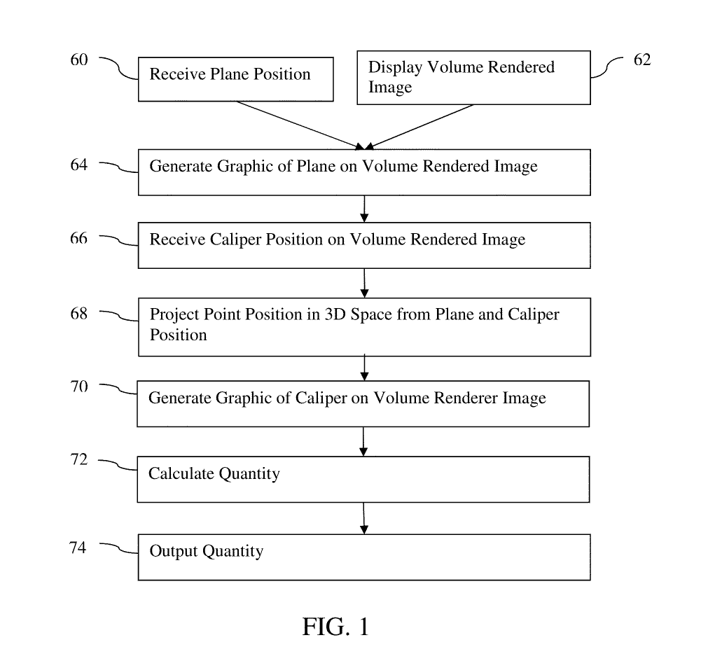

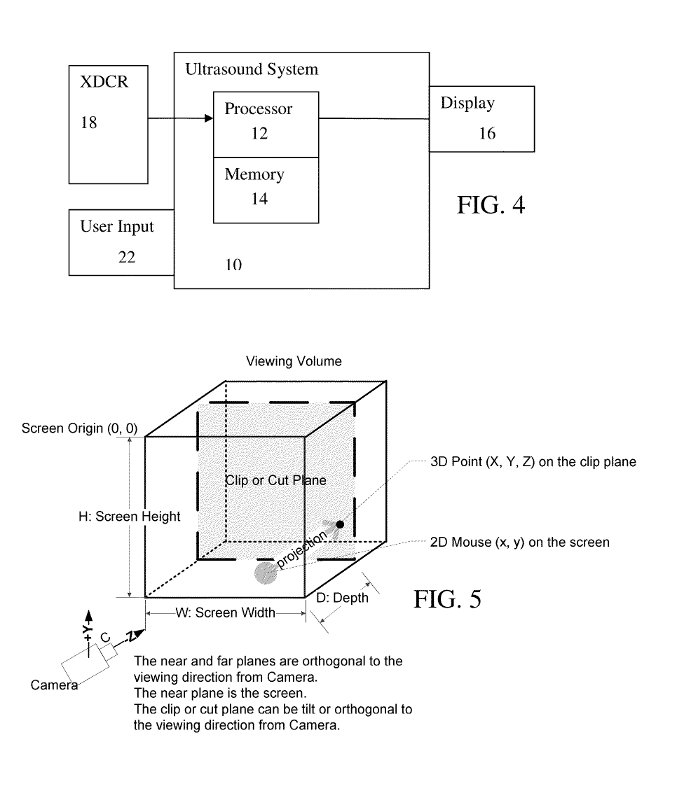

FIG. 1 shows a method for measuring in ultrasound volume rendering. The method is implemented by a medical diagnostic imaging system, a review station, a workstation, a computer, a PACS station, a server, combinations thereof, or other device for image processing medical ultrasound or other types of volume data. For example, the ultrasound system 10 or memory 14 and processor 12 shown in FIG. 4 implements the method, but other systems may be used.

The examples herein are provided for ultrasound imaging. In alternative embodiments, other medical modalities capable of three-dimensional imaging are used, such as magnetic resonance, computed tomography, positron emission tomography, single photon emission computed tomography, or x-ray.

The method is implemented in the order shown or a different order. Acts 60 and 62 are performed in any order or simultaneously. Act 64 may be performed simultaneously with act 62.

A same data set representing a volume is used for all of the acts 60-74. The acts are performed either in real-time with scanning or in a post scan review, but using a freeze operation or selection of a given data set to use for measurement. Alternatively, the acts 60-74 are performed in real-time, such as during scanning, while the data set is updated. The user may view and interact with images while scanning. The images may be associated with previous performance of acts 60-70 in the same imaging session, but with different volume data. For example, act 62 is performed for an initial scan. Acts 60, 64, 66, 68, 70 and/or 72 are performed for subsequent scans during the same imaging session but on images generated with subsequent scans. For real-time imaging, the volume data used for any given image may be replaced with more recently acquired data. For example, an initial volume rendering is performed with one set of data. The final rendering is performed with another set of data representing the same or similar (e.g., due to transducer or patient movement) volume.

Additional, different, or fewer acts may be performed. For example, act 74 is optional. As another example, scanning is performed to acquire the data used for the display in act 62.

For scanning, an ultrasound transducer is positioned adjacent, on, or within a patient. A volume scanning transducer is positioned, such as a mechanical wobbler, a transesophageal echocardiogram (TEE) array, or multi-dimensional array. For adjacent or on a patient, the transducer is positioned directly on the skin or acoustically coupled to the skin of the patient. For within the patient, an intraoperative, intercavity, cardiac catheter, TEE, or other transducer positionable within the patient is used to scan from within the patient.

The user may manually position the transducer, such as using a handheld probe or manipulating steering wires. Alternatively, a robotic or mechanical mechanism positions the transducer.

The volume region of the patient is scanned, such as scanning an entire heart or portion of the heart from the esophagus or through another acoustic window. Other organs or parts of a patient may be scanned. One or more objects, such as the heart, an organ, a vessel, fluid chamber, clot, lesion, muscle, and/or tissue are within the region. The array generates acoustic energy and receives responsive echoes.

One or more sets of ultrasound data are obtained. The ultrasound data corresponds to a displayed image (e.g., detected and scan converted ultrasound data), beamformed data, detected data, and/or scan converted data. The ultrasound data represents a region of a patient. Data for multiple planar slices may represent the volume region. Alternatively, a volume scan is used.

The ultrasound data is of any volume imaging mode, such as flow mode or B-mode. Flow mode includes Doppler or other estimates of motion (e.g., color or Doppler velocity or energy). The shape of a structure or spatial aspect may be reflected in B-mode data.

In act 62, a display displays a volume rendered image of a volume of tissue scanned by ultrasound. Using surface rendering, projection, or other volume rendering technique, the data representing the volume is rendered to an image. A processor or graphics processing unit renders the image on the display.

The image includes information from the entire volume or a non-planar portion of the volume. For example, the value of a given pixel is determined from multiple voxels along a line passing along a viewing direction through the pixel. Using comparison, a value of a surface (e.g., highest or first above a threshold) is selected. In another approach, alpha blending or other projection approach combines data along the line. The volume rendered image is generated from data spaced in three dimensions rather than being of a plane in the volume.

In act 60, a position of a plane is received. A user operates a user input to control the position of a plane. An initial position of the plane is input. Alternatively, a position of the previously plane is changed. The processor receives the position information from the user input. Alternatively, the plane may be positioned by the processor with or without user input.

The plane is positioned relative to the scanned volume. The plane may have any arbitrary position relative to the volume, such as along or not along one or more of the Cartesian coordinate dimensions of the volume or the viewing direction.

In one embodiment, the plane has a purpose other than measurement. The plane is provided for a use other than deriving or defining the point position in measurement. For example, the plane is a clip plane or an image plane. The image plane may be for MPR or may be a single image plane of the volume. Given this other purpose, changes in the plane result in changes in imaging. For example, a user changes a clip plane and the change also alters the volume rendered image. Different data is cropped from the volume, so different data of the set of ultrasound data is used to render the image. By adjusting the clip plane position relative to the volume, the volume rendering is also adjusted. As another example, changing an image plane results in a different two-dimensional cross-section image being displayed with the volume rendered image.

One possible plane position received in act 60 is the position of one or more cut planes or image planes. For example, the user positions the planar region relative to the volume in any arbitrary position. As another example, the user positions multiple planes for MPR.

Any now known or later developed MPR control may be used. In act 60, the relative position of the planes is established in any manner. Any MPR approach may be used. For example, the user adjusts the position and/or orientation of one or more planes. The user may be seeking to locate a standard, preferred, or diagnostic view for one, more, or all of the planes. Different views are provided by the different planes. Using a click and drag or other user entry, a plane is translated and/or rotated to a desired position.

In another approach, a processor or automatic detection of the planar positions is used. For example, anatomical features are detected. As another example, a machine-learned classifier locates the plane positions from the data representing the patient. Planes are positioned relative to the anatomy.

In yet another approach, the planar positions are established relative to the transducer. For example, the azimuth, elevation and range (depth) dimensions of the transducer define three orthogonal planes. Other orientations relative to the transducer may be used, such as one likely to provide standard heart images given a selected or assigned acoustic window used to scan the volume.

The relative position of the planes may be for user created positioning, standard positioning, default positioning, and/or reference positioning. For example, a reference position may be relative to the transducer, likely recognized by the user, or arbitrary. Standard positioning corresponds to providing standard views, such as A2C, A4C, and LAX views. Default positioning is an initial, predetermined, or set position, which may be a reference or standard position, but may not be. The default may be a user selected preference positioning.

A two-dimensional image of a planar part of the volume is generated adjacent to the volume rendered image. The planar part is independent of the volume rendered (VR) view direction or is orientated based on the MPR view direction. The MPR images may stay the same while the VR viewing direction changes since the same planes are being imaged regardless of a change in viewing direction of the volume rendered image.

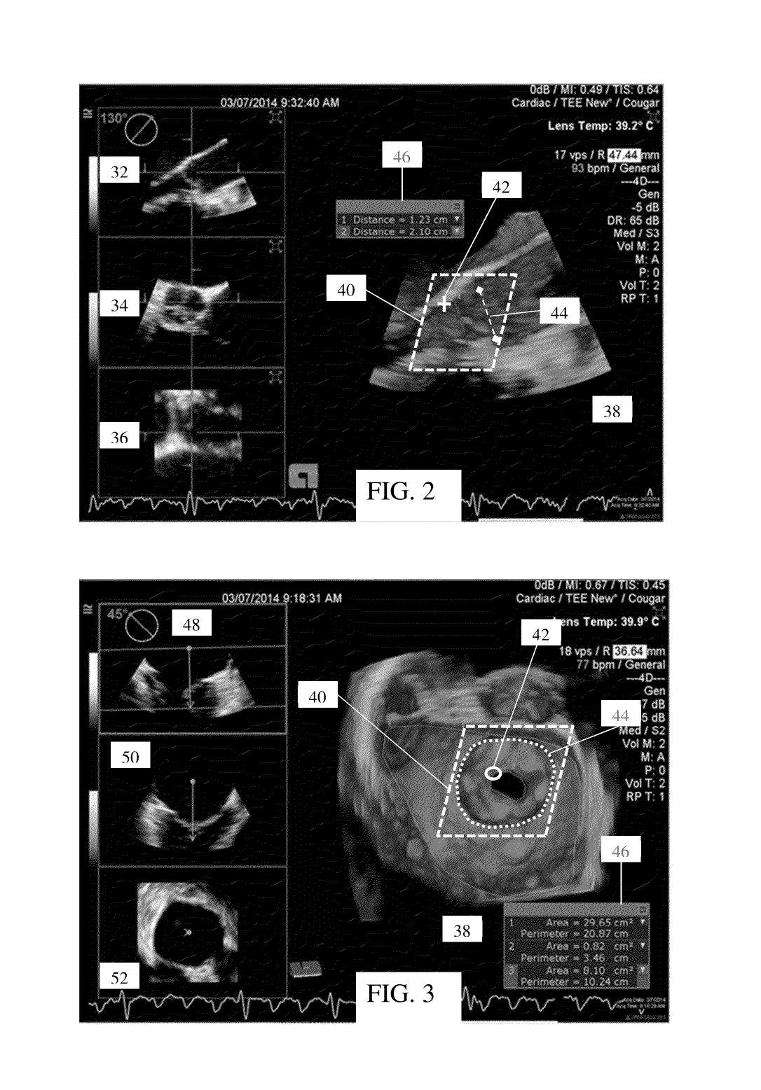

In act 62, the positioned plane of act 60 is used by the processor in generating the volume rendering or to generate an image displayed with the volume rendered image. For MPR or cut plane, the positioned plane is used to generate one or more images. The MPR is for one, two, three, or more planes. FIG. 2 shows three MPR images 32, 34, and 36. The MPR images 32-36 are planar images for conceptual planes through the volume. Data along or adjacent to each plane is used to generate an MPR image 32-36. In the example of FIG. 2, the three MPR images 32-36 are for three planes orthogonal to each other with all three planes intersecting in a middle of each plane section. Each MPR image 32-36 includes a horizontal and vertical line showing the intersection of the other planes. These lines are added graphics. Any MPR user interface may be used.

In the example of FIG. 2, a volume rendered image 38 is provided on the screen with the MPR images 32-36. The volume rendered image 38 is from any viewing direction, such as orthogonal to one of the MPR images (e.g., MPR image 32) as a default.

Another possible plane position received in act 60 is the position of one or more clip planes. Any now known or later volume rendering editing may be used to position the clip plane or planes. For example, MPR lines, D'Art, Dual V, Box edit, or other clip tools are used. Multiple clip planes that are parallel or not parallel may be positioned. A three-dimensional object may be used for cropping, such as fitting an anatomy model or a cube over anatomy of interest and cropping data not encompassed by the three-dimensional clipping object. The three-dimensional clipping object defines a plurality of planes or a surface formed of planes. The position of the clipping planes allows viewing of the desired anatomy with less or no interference by other tissue.

For using the plane positioned in act 60 to generate the volume rendered image in act 62, the clip plane defines the part of the volume to be rendered. Any now known or later developed tool may be used to manipulate the clip plane. For example, the same or different operations for MPR may be used to position the clip plane or planes (e.g., click and drag or rotate).

In one embodiment, two clip planes are defined so that the user may select a slab in three dimensions for rendering. FIG. 3 shows an example. The image 48 is a cross-section or planar image of the volume provided to show a distance between two planes to define the slab. The planes are represented as lines with an arrow indicating the viewing direction orthogonal to the planes. The image 50 shows a different planar cross-section. The image 52 shows a top view or image of the clip plane closest to the view point for rendering. Other arrangements of images for positioning the clip plane or planes may be used.

The defined clip plane locations are automatically or manually applied to the volume rendered image. In one embodiment, the three-dimensional representation of the volume (e.g., the volume rendered image) is for a standard diagnostic view. A rendering or clipping plane is parallel or substantially parallel (e.g., substantially accounts for a 10 degree or less offset to view a valve or other internal structure) to a standard two-dimensional view. For example, the clip plane corresponds to an A4C view, an A2C view, a LAX, or other standard view, and the viewing direction corresponds to an orthogonal to the clip plane with or without an offset. The displayed representation may be labeled (e.g., A4C) and/or annotated (e.g., valve highlighted).

Other adjustments may be made to the volume rendered image. For example, the user rotates, translates or otherwise alters the VR viewing direction. The plane position is relative to the volume, so a change in VR view direction does not alter the position of the plane relative to the volume. The direction of the view relative to the plane changes. As the VR view direction changes, the volume rendered image is re-rendered from the new view direction.

In act 64 of FIG. 1, a graphic representing the plane (e.g., clip or cut plane) is generated on the volume rendered image. The processor causes the graphic to be displayed on the screen with the volume rendered image. The graphic is over the volume rendered image such that the graphic covers some of the tissue representation. The graphic may be larger, such as surrounding the tissue representation. The graphic may be positioned beside the tissue representation. In alternative embodiments, the graphic is not generated and not displayed.

Any graphic may be used. For example, a wire frame box or parallelogram is generated. FIGS. 2 and 3 show the wire frame 40. The representation has any extent, such as representing a portion of the plane. The graphic may alternatively be larger than the volume rendered image, so not cover any tissue.

The graphic indicates the position of the plane relative to the volume rendered image, so relative to the viewing direction. Where the plane is orthogonal to the VR view direction, the graphic is of a square or rectangle. Where the VR view direction is not orthogonal, the graphic may be a parallelogram or other shape showing the skew or perspective of the plane relative to the view direction for the volume rendering. As the VR view direction changes, the perspective of the graphic changes.

The graphic is generated automatically with the volume rendered image. Alternatively, the graphic is not added until the user initiates a measurement tool. In response to the user indicating a desire to measure anatomy, the graphic is added to the volume rendering.

The graphic represents the clip plane in one embodiment. While an image of the clip plane may or may not be shown, the graphic shows the position of the clip plane relative to the volume being rendered. Since the clip plane establishes a boundary of the volume rendering, the volume rendered image has pixels responsive, in part, to data along the plane. Since data spaced from the plane is also used, the volume rendering without the graphic may not easily show the position of the plane relative to the volume.

In another embodiment, the graphic represents one or more of the MPR planes. While an image of the cut plane is shown in MPR, the graphic represents the location of the cut plane relative to the volume rendered image. The graphic may be part of an icon or set of graphics representing multiple or all of the image planes relative to the volume. Rather than being on the volume rendered image, the graphic may be beside the volume rendered image, such as part of an object to represent position of the planes relative to the volume and view direction. The plane represented may be selectable or variable, such as providing the graphic on the volume rendered image just for the most orthogonal MPR plane.

In act 66, a position of a measurement caliper on the volume rendered image is received. The processor receives the position from the user input. The user places a caliper 42 or measurement indication on the volume rendered image 38. The user positions the caliper 42 at the desired location for measuring.

The input device provides a user selected measurement location on the rendered volumetric image of the three-dimensional object. The point or location on the screen corresponds to a range of possible depths relative or along the viewing direction of the volume rendered image.

The measurement location is projected to the plane. To define the depth, the caliper 42 is projected on or in the graphic representing the clip plane or image plane. Upon receipt of activation of the measurement function, the graphic of the caliper 42 is generated. The measurement location is received as being in the graphic of the plane on the rendered volumetric image. In alternative embodiments, the graphic is not provided, but the caliper 42 is assumed to be positioned on the plane within the imaged volume.

The positions of more than one caliper 42 may be received. For a distance measurement, the positions of two or more calipers or measurement shapes 44 are received and the distance, area or other results 46 are displayed. For area or volume measurements, three or more caliper positions 44 may be received and the area results 46 are displayed. The processor may perform boundary detection and/or curve fitting to further define the area or volume in a semi-automated manner.

Where more than one plane is represented by graphics in the volume rendered image, the different calipers 42 may be positioned in different planes. For example, the user alters the VR viewing direction so that a graphic for the plane of interest shows the location of interest without interference or overlap with graphics for other planes. The location is selected by the user. The process is repeated to place different calipers 42 on different graphics of the respective different planes. Alternatively, the plane position as shown is used for one caliper 42. The plane position is then altered or changed in act 60 for receiving a position of a different caliper 42 in act 66. In other embodiments, multiple caliper positions use the same plane to define the depth for the respective locations.

In act 68, the processor computes a point position in the volume space. The processor converts a point in two-dimensional Cartesian coordinates into three-dimensional coordinates of the volume. The location of the caliper 42 on the volume rendered image indicates position in two dimensions or the lateral location. The depth along the VR viewing direction is not provided just by selection of caliper 42 location on the two-dimensional screen. The processor computes the position as a point in three-dimensional space, so provides a depth as well. The point in the lateral dimensions and the depth dimension or the point in three dimensions is defined.

The depth is defined by the plane position relative to the volume. The plane may be at different depths for different lateral locations. Where the plane is orthogonal to the viewing direction of the volume rendered image, the plane is at the same depth for each lateral location. Where the plane is not orthogonal, the depth of the plane along the viewing direction is different for different lateral locations. Based on the lateral location of the caliper 42 or received position on the volume rendered image, the depth is determined using the plane position relative to the volume. The clip or cut plane is used to derive the point in three dimensions from the volume rendered image, defining the point in the volume space. The point is defined as being on the plane (e.g., clip plane or cut plane) in the volume at the lateral location indicated by the caliper placement on the volume rendered image 38. The depth, where the caliper is placed, is defined by the position of a plane along the viewing direction so that the point may be transformed to the 3D Cartesian or other coordinate space for a direct measurement.

By positioning the caliper 42 on the graphic representing the plane position relative to the volume, the depth may be, at least somewhat, indicated to the user. The graphic indicates the definition of the depth to be used by the processor. In alternative embodiments, the graphic is not provided. The depth is defined based on the plane position regardless of whether the user understands that the plane is used to define depth or not. FIG. 5 shows an example of projection from the screen space of the VR image to an orthogonal clip or cut plane to define the point location in the volume space.

The point position and resulting measurements are independent of the volume rendering viewing direction. Since the plane rotates or changes perspective with any change in viewing direction, the point position stays the same relative to the volume. The plane position defines the location and is fixed, unless changed by the user, relative to the volume. As the perspective from which the volume is viewed changes, the perspective of the plane changes in the same way. The points that are members of the plane stay the same, so the measurement point defined by the processor is independent of the viewing direction once defined. The volume rendering may be rotated for placing other calipers 42 without changing the location in the volume defined by a previously placed caliper 42. Where the plane position is altered relative to the volume, previously defined points may stay the same or may be altered with the plane.

In act 70, a graphic representing the placed caliper (e.g., a dash line or a dash contour) is generated on the volume rendered image. The processor causes the graphic to be displayed on the screen with the volume rendered image. The graphic is over the volume rendered image such that the graphic covers some of the tissue representation. The graphic may be larger, such as surrounding the tissue representation. The graphic may be positioned beside the tissue representation. In alternative embodiments, the graphic is not generated and not displayed.

In act 72, the processor calculates a quantity. Any quantity may be calculated. For example, a distance between two end points is calculated. By placing calipers at different locations in tissue, a distance between the locations is measured. A size of a lesion, a length of a fetus, a width or length of a bone, or other anatomy may be measured. As another example, an area, circumference, volume, or other spatial measure is performed.

The processor uses the defined point or points for calculating. For distance, the distance between two end points positioned in the volume is calculated. The spatial extent of the volume or size of voxels is known from the scan geometry. By defining two end points in three-dimensional space, a distance between the points is calculated. The distance is in reference to three-dimensional space rather than being a distance between points in two dimensions. In some embodiments, both points may be on a same plane, so orienting the plane provides the desired distance rather than a simplified distance using two-dimensional calipers on a volume rendered image.

For area, volume, circumference, or other measurements, more than two points may be defined. The user may indicate the locations in three-dimensional space for seeds. The processor performs boundary detection, such as using thresholding, random walker or gradient processing, using the seed points to identify the boundary used in the calculation.

A spatial aspect of the three-dimensional object represented by the ultrasound data is measured. The measurement is based on one or more locations input on a volume rendered image and a measurement depth defined by a plane associated with the volume rendered image.

In act 74, the quantity is output. The processor outputs the quantity to a display. The quantity is displayed adjacent to, on, or separate from the volume rendered image. For example, the distance between two calipers 42 is displayed over the tissue representation of the volume rendered image or in the background but not over the tissue representation. Other outputs include output to a printer, to a memory, or over a network.

The quantity is output as a textual or numerical value. In other embodiments, the quantity is output in a graph, chart, waveform, spreadsheet, or other indicator of the quantity. The quantity may be output by itself or in combination with other values. For example, the measurement over time or a sequence of volume datasets through a heart or breathing cycle is output. As another example, the quantity is output with other quantities representing the norm, deviation, or abnormal results. Other outputs on the VR image may be provided, such as the graphic representation of clip or cut planes and measurement caliper.

FIG. 4 shows a medical diagnostic imaging system 10 for measuring in ultrasound volume rendering. The system 10 is a medical diagnostic ultrasound imaging system, but may be a computer, workstation, database, server, or other imaging system. Other medical imaging systems may be used, such as a computed tomography or a magnetic resonance system.

The system 10 implements the method of FIG. 1 or a different method. The system 10 provides a direct measurement tool on the rendered volumetric image. Using the system 10, clinicians may measure the anatomy of interest and evaluate the relative position of the structures in the volumetric image with accurate measurements between points defined in three-dimensional rather than two-dimensional space. The measurement locations specific to a point in a volume may allow measurements of the overall three-dimensional geometry of a scanned object. The measurements are the same regardless of different orientations or perspectives of the rendering of a scan volume of the object. The measurements account for depth dimension in volume rendering.

The system 10 includes a processor 12, a memory 14, a display 16, a transducer 18, and a user input 22. Additional, different, or fewer components may be provided. For example, the system 10 includes a transmit beamformer, receive beamformer, B-mode detector, Doppler detector, harmonic response detector, contrast agent detector, scan converter, filter, combinations thereof, or other now known or later developed medical diagnostic ultrasound system components. As another example, the system 10 does not include the transducer 18.

The transducer 18 is a piezoelectric or capacitive device operable to convert between acoustic and electrical energy. The transducer 18 is an array of elements, such as a one-dimensional, multi-dimensional, or two-dimensional array. For example, the transducer 18 is a transesophageal echocardiogram (TEE) probe. Alternatively, the transducer 18 is a wobbler for mechanical scanning in one dimension and electrical scanning in another dimension.

The system 10 uses the transducer 18 to scan a volume. Electrical and/or mechanical steering allows transmission and reception along different scan lines in the volume. Any scan pattern may be used. In one embodiment, the transmit beam is wide enough for reception along a plurality of scan lines, such as receiving a group of up to sixteen or more receive lines for each transmission. In another embodiment, a plane, collimated or diverging transmit waveform is provided for reception along a plurality, large number, or all scan lines.

Ultrasound data representing a volume is provided in response to the scanning. The ultrasound data is beamformed by a beamformer, detected by a detector, and/or scan converted by a scan converter. The ultrasound data may be in any format, such as polar or Cartesian coordinates, Cartesian coordinate with polar coordinate spacing between planes, or other format. In other embodiments, the ultrasound data is acquired by transfer, such as from a removable media or over a network. Other types of medical data representing a volume may also be acquired.

The memory 14 is a buffer, cache, RAM, removable media, hard drive, magnetic, optical, or other now known or later developed memory. The memory 14 may be a single device or group of two or more devices. The memory 14 is shown within the system 10, but may be outside or remote from other components of the system 10.

The memory 14 stores the ultrasound data. For example, the memory 14 stores flow or tissue motion estimates (e.g., velocity, energy or both) and/or B-mode ultrasound data. The medical image data is a three-dimensional data set (e.g., data representing acoustic response from locations distributed in three dimensions (n×m×o where n, m and o are all integers greater than 1)), or a sequence of such sets. For example, a sequence of sets over a portion, one, or more heart cycles of the heart are stored. A plurality of sets may be provided, such as associated with imaging a same patient, organ or region from different angles or locations. The data represents a volume of a patient, such as representing a portion or all of the heart.

For real-time imaging, the ultrasound data bypasses the memory 14, is temporarily stored in the memory 14, or is loaded from the memory 14. Real-time imaging may allow delay of a fraction of seconds, or even seconds, between acquisition of data and imaging. For example, real-time imaging is provided by generating the images substantially simultaneously with the acquisition of the data by scanning. While scanning to acquire a next or subsequent set of data, images are generated for a previous set of data. The imaging occurs during the same imaging session used to acquire the data. The amount of delay between acquisition and imaging for real-time operation may vary, such as a greater delay for initially locating planes of a multi-planar reconstruction with less delay for subsequent imaging. In alternative embodiments, the ultrasound data is stored in the memory 14 from a previous imaging session and used for imaging without concurrent acquisition.

For measurement, only one dataset may be used. Only one dataset or scan of a volume is acquired, or one is selected from a sequence, such as using a “freeze” operation. Alternatively, the measurements are made while real-time imaging is provided.

The memory 14 is additionally or alternatively a computer readable storage medium with processing instructions. The memory 14 stores data representing instructions executable by the programmed processor 12 for measuring in ultrasound volume rendering. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The user input 22 is a button, slider, knob, keyboard, mouse, trackball, touch screen, touch pad, combinations thereof, or other now known or later developed user input devices. The user may operate the user input 22 to set rendering values (e.g., define a clip plane, select a type of rendering, or set an offset angle), select MPR plane arrangements, alter a position of one or more planes, select a measurement location on a volume rendered image, and/or operate the system 10. For example, the user input 22 receives from the user an indication of a position of a plane relative to the volume. Clip plane or cut plane positioning using any user interface operations may be used. As another example, the user input 22 receives from the user indication of change in plane position relative to the volume and/or alteration of the viewing direction for volume rendering. In yet another example, the user input 22 receives from the user a measurement location indicated on a volume rendering of a volume of the patient. A plurality of such measurement locations may be received.

The processor 12 is a general processor, digital signal processor, three-dimensional data processor, graphics processing unit, application specific integrated circuit, field programmable gate array, digital circuit, analog circuit, combinations thereof, or other now known or later developed device for processing medical image data. The processor 12 is a single device, a plurality of devices, or a network. For more than one device, parallel or sequential division of processing may be used. Different devices making up the processor 12 may perform different functions, such as a volume rendering graphics processing unit and a control processor for calculating measurements operating separately. In one embodiment, the processor 12 is a control processor or other processor of a medical diagnostic imaging system, such as a medical diagnostic ultrasound imaging system processor. In another embodiment, the processor 12 is a processor of an imaging review workstation or PACS system. In yet another embodiment, the processor 12 is a volume rendering processor.

The processor 12 is configured by hardware and/or software. For example, the processor 12 operates pursuant to stored instructions to perform various acts described herein, such as acts 60, 64, 66, 68, 70, 72, and 74 of FIG. 1.

The processor 12 is configured to generate a volume rendering of the volume of the patient from the ultrasound data. Any type of volume rendering may be used, such as projecting along ray lines from a view point or in a view direction. Lighting, transfer function, or other volume rendering operations may be provided.

In one embodiment, the processor 12 generates the volume rendering with the volume cropped by one or more clipping planes or other clipping objects. For example, the user defines a slab using parallel clipping planes. The ultrasound data between the clipping planes is used to generating the volume rendering.

In another embodiment, the processor 12 generates one or more images from cut planes. One or more planes through the volume (e.g., cross-sections of the volume) are defined or positioned. The processor 12 interpolates, selects, or interpolates and selects ultrasound data of the volume data set that represents the corresponding plane. The data is then used to generate an image of the plane, such as in MPR.

The processor 12 is configured to generate a graphic representing the plane in the volume rendering. The graphic is a wire frame or other indicator of the position of the plane relative to the volume rendering.

The processor 12 is configured to compute a position in the volume. The processor 12 receives an indication of a measurement location. For example, a placement or activation of a measurement caliper on the volume rendering is received. The location may or may not be within the wire frame of the graphic. Using the user input location on the volume rendering and the position of the plane relative to the volume, a unique position within the volume is defined. The unique position is defined or identified laterally by placement on the two-dimensional screen and in depth by projection of the lateral location along the current viewing direction to the plane. Multiple such unique positions may be received for measuring. Multiple clip or cut planes are available for defining different measurement locations.

The position defined by the processor 12 is independent of a view direction of the volume rendering. The cut planes and/or clip planes are not limited to orthogonal planes from a user's viewing direction. The user may adjust a cut plane or select which clip plane to use to define the depth along the viewing direction in computing the measurement location. The computed location is specific to the anatomy or volume regardless of the direction from which the volume is rendered.

The processor 12 is configured to generate a graphic representing the measurement locations in the volume rendering. The graphic is a dash polyline or other indicator of the measurement locations relative to the volume rendering.

The processor 12 is configured to calculate a value as a function of the position in the volume. Using the measurement locations, the processor 12 calculates a value, such as a distance. The display 16 is a CRT, LCD, plasma, monitor, projector, printer, or other now known or later developed display device. The display 16 is configured by loading an image from the processor into a display buffer. Alternatively, the display 16 is configured by reading out from a display buffer or receiving display values for pixels.

The display 16 is configured to display a volume rendering, clip plane navigation user interface, MPR images, plane graphics, calipers, measurement graphics and/or user interface tools. The volume rendering is displayed by itself or in combination with images of planes. Multiple images may be displayed in different portions of a screen of the display 16, such as in different windows. The display 16 is configured to display a value, such as a quantity calculated in measuring.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. A method for measuring in ultrasound volume rendering, the method comprising:
displaying, on a display, a volume rendered image of a volume of tissue scanned by ultrasound;
generating a graphic representing a clip plane or cut plane on the volume rendered image;
receiving, from a user input, positioning of a measurement caliper on the volume rendered image and in the graphic representing the clip plane or cut plane;
defining, by a processor, a point position in the volume based on the clip plane or cut plane relative to the volume and the positioning of the measurement caliper on the volume rendered image;
calculating, by the processor, a quantity as a function of the point position in the volume; and
outputting the quantity.

2. The method of claim 1 wherein displaying comprises displaying a projection along a viewing direction of the volume.

3. The method of claim 1 wherein displaying comprises displaying the volume rendered image of the volume with a portion of the volume cropped by the clip plane, and wherein generating the graphic comprises generating the graphic representing the clip plane.

4. The method of claim 1 wherein generating the graphic comprises generating a wireframe box or parallelogram.

5. The method of claim 1 wherein displaying further comprises displaying a multi-planar reconstruction image of the cut plane adjacent to the volume rendered image, and wherein generating the graphic comprises generating the graphic representing the cut plane of the multi-planer reconstruction image.

6. The method of claim 1 further comprising:
receiving, from the user input, a position of the clip plane or the cut plane relative to the volume, the clip plane or the cut plane provided for a use other than defining the point position.

7. The method of claim 1 further comprising:
adjusting, in response to input from the user input, the volume rendered image, the adjusting corresponding to moving the clip plane relative to the volume, altering a viewing direction, or both.

8. The method of claim 7 wherein adjusting comprises the altering of the viewing direction, and wherein generating the graphic comprises altering a perspective of the graphic.

9. The method of claim 1 wherein receiving comprises receiving activation with a cursor positioned on the volume rendered image in the graphic.

10. The method of claim 1 wherein defining the point position comprises computing the point position along three dimensions in the volume as a point on the clip plane or the cut plane indicated by the measurement caliper on the graphic on the volume rendered image.

11. The method of claim 1 further comprising generating a graphic representing a measurement caliper on the volume rendered image, the graphic comprising a dash line or other polyline.

12. The method of claim 1 wherein calculating comprises calculating a distance as the quantity, the point position being an end point of the distance.

13. The method of claim 1 wherein outputting the quantity comprises displaying the quantity adjacent to or on the volume rendered image.

14. A system for measuring in volume rendering, the system comprising:
a memory operable to store data representing a volume of a patient;
a user input configured to receive an indication of a position of a plane relative to the volume and a measurement location on a volume rendering of the volume;
a processor configured to generate the volume rendering of the volume from the data, to compute a position in the volume from the measurement location on the volume rendering and the position of the plane relative to the volume, and to calculate a value as a function of the position in the volume; and
a display configured to display the volume rendering and the value.

15. The system of claim 14 wherein plane comprises one or more clipping planes, wherein the processor is configured to generate the volume rendering with the volume cropped by the clipping planes.

16. The system of claim 14 wherein the plane comprises one or more imaging cut planes, wherein the processor is configured to generate an image of the imaging cut plane adjacent to the volume rendering.

17. The system of claim 14 wherein the processor is further configured to generate a graphic representing the plane in the volume rendering, and wherein the measurement location is within a frame of the graphic.

18. The system of claim 14 wherein the position is independent of a view direction of the volume rendering.

19. In a non-transitory computer readable storage medium having stored therein data representing instructions executable by a programmed processor for measuring in ultrasound volume rendering, the storage medium comprising instructions for:
receiving from an input device a measurement location on a rendered volumetric image of a three-dimensional object;
defining measurement depth relative to the three-dimensional object based on a position of a plane along a viewing direction of a rendered volumetric image; and
measuring a spatial aspect of the three-dimensional object based on the measurement location and the measurement depth.

20. The non-transitory computer readable storage medium of claim 19 wherein receiving comprises receiving the measurement location in a graphic on the rendered volumetric image.

21. The non-transitory computer readable storage medium of claim 19 wherein defining comprises defining with the plane being multiple clip planes or multiple cut planes.
